(19) United States
(12) Patent Application Publication
(10) Pub. No.: US 2011/0094612 A1
(43) Pub. Date: Apr. 28, 2011

(54) MULTILAYER TUBE FOR TRANSPORTING WATER OR GAS

(76) Inventors: Anthony Bonnet, Beaumont Le Roger (FR); Aude Lapprand, Paris (FR); Pascal Sebire, Sant-Aubin Le Vertueux (FR)

(21) Appl. No.: 12/376,658

(22) PCT Filed: Aug. 7, 2007
(86) PCT No.: PCT/FR2007/051793

§ 371 Date: Dec. 23, 2010

(30) Foreign Application Priority Data
Aug. 8, 2006 (FR) 0653319

(51) Int. Cl. F16L 9/14

(52) U.S. Cl. 138/140

(57) ABSTRACT

The invention relates to a multilayer tube comprising (in the order from the inside to the outside of the tube), layers arranged one on top of the other: an optional layer L₁ comprising at least one fluorinated polymer, preferably a PVDF; a layer L₂ comprising at least one functionalized PVDF, obtained by radiation-grafting of at least one unsaturated polar monomer onto a PVDF; an optionally layer L₃ of an adhesion binder; a layer L₄ comprising at least one polyolefin optionally mixed with at least one functionalized polyolefin; an optional barrier layer L₅; an optional layer L₆ comprising at least one polyolefin, optionally in a mixture with at least one functionalized polyolefin; characterized in that the PVDF onto which the unsaturated polar monomer is grafted is a VDF copolymer those weight content is at least 50%, preferably at least 75%, and at least one monomer copolymerizable with the VDF, having the following characteristics: a crystallization temperature T_{c} (measured by DSC as per the ISO Standard 11357-3) ranging from 50 to 120° C., preferably 85 to 110° C.; a yield strength σ_{Y} ranging from 10 to 40 MPa, preferably 10 to 30 MPa; and a melt viscosity η (measured with a capillary rheometer at 230° C. at 100 s⁻¹) ranging from 100 to 1500 Pa·s, preferably 400 to 1200 Pa·s.”

### FIELD OF THE INVENTION

The present invention relates to a multilayer pipe comprising a layer of a functionalized PVDF obtained by radiation-grafting at least one unsaturated monomer onto a PVDF and a layer of a polyolefin. The polyolefin may be a polyethylene, especially a high-density polyethylene (HDPE) or a crosslinked polyethylene (denoted by PEX). The pipe may be used for transporting liquids, in particular hot water, or gases. The invention also relates to the uses of this pipe.

### TECHNICAL PROBLEM

Steel or cast iron pipes are being increasingly replaced with equivalents made of plastic. Polyolefins, especially polyethylenes, are thermoplastics widely used as they exhibit good mechanical properties, they are easily converted and can be easily bonded to one another. Polyolefins are widely used for the manufacture of pipes for transporting water or town gas. When the gas is under high pressure (>10 bar, or higher), it is necessary for the polyolefin to be mechanically resistant to the stresses exerted by the pressurized gas.

Moreover, the polyolefin may be exposed to an aggressive chemical environment. For example, in the case of transporting water, the water may contain additives or aggressive chemicals (for example ozone and chlorinated derivatives used for purifying water, such as bleach, which are oxidizing, especially when hot). These additives or chemicals may damage the polyolefin over the course of time, especially when the transported water is at a high temperature (which is the case in heating circuits or in water networks in which the water is raised to a high temperature in order to eliminate germs, bacteria or microorganisms). One problem that the invention is intended to solve is therefore to develop a chemically resistant pipe.

Another problem that the invention is intended to solve is that the pipe has to have barrier properties. The term “barrier” is understood to mean the fact that the pipe stops migration of contaminants present in the external environment or else contaminants (such as antioxidants or polymerization residues) present in the polyolefin into the transported fluid. The term “barrier” is also understood to mean the fact that the pipe stops migration of oxygen or additives present in the transported fluid into the polyolefin layer.

It is also necessary for the pipe to have good mechanical properties, in particular good impact strength, and for the layers to adhere well to each other (no delamination).

The Applicant has developed a multilayer pipe that solves the stated problems. In particular, this pipe has good chemical resistance with respect to the transported fluid and also the abovementioned barrier properties.

### PRIOR ART

Document EP 1484346 published on 8 Dec. 2004 describes multilayer structures that include a functionalized fluoropolymer obtained by radiation grafting. The structures may be in the form of bottles, tanks, containers or hoses. The structure of the multilayer pipe according to the invention does not appear in that document.

Document EP 1541343 published on 8 Jun. 2005 describes a multilayer structure based on a functionalized fluoropolymer obtained by radiation grafting in order to store or transport chemicals. In this application, the term “chemicals” should be understood to mean products that are corrosive or dangerous, or else products whose purity has to be maintained. The structure of the multilayer pipe according to the invention does not appear in that document.

Document U.S. Pat. No. 6,016,849 published on 25 Jul. 1996 describes a plastic pipe in which the adhesion between the internal layer and the external protective layer is between 0.2 and 0.5 N/mm, There is no mention of a functionalized fluoropolymer obtained by radiation grafting.

Documents US 2004/0206413 and WO 2005/070671 disclose a multilayer pipe that includes a metal sheath. It does not mention a functionalized fluoropolymer obtained by radiation grafting.

### BRIEF DESCRIPTION OF THE INVENTION

The invention relates to a multilayer pipe which, according to the first embodiment comprises (in order from the inside of the pipe outwards), placed against one another:
optionally, a layer L₁ comprising at least one fluoropolymer, preferably a PVDF;
a layer L₂ comprising at least one functionalized PVDF, obtained by radiation-grafting at least one unsaturated polar monomer onto a PVDF;
optionally, a layer L₃ of an adhesion tie;
a layer L₄ comprising at least one polyolefin optionally blended with at least one functionalized polyolefin;
optionally, a barrier layer L₅; and
optionally, a layer L₆ comprising at least one polyolefin, optionally blended with at least one functionalized polyolefin,
   characterized in that the PVDF onto which the unsaturated polar monomer is grafted is a copolymer of VDF, the weight content of which is at least 50%, preferably at least 75%, and at least one monomer copolymerizable with VDF, having the following characteristics:
a crystallization temperature T_{c} (measured by DSC according to ISO 11357-3 standard) ranging from 50 to 120° C., preferably 85 to 110° C.;
a yield strength ay ranging from 10 to 40 MPa, preferably 10 to 30 MPa; and
a melt viscosity η (measured by capillary rheometry at 230° C./100 s⁻¹) ranging from 100 to 1500 Pa·s, preferably 400 to 1200 Pa·s.

According to a second embodiment, the multilayer pipe comprises (in order from the inside of the pipe outwards) placed against one another:
optionally, a layer L′₁ comprising at least one fluoropolymer, preferably a PVDF;
a layer L′₂ comprising at least one functionalized PVDF, obtained by radiation-grafting at least one unsaturated monomer onto a PVDF;
a barrier layer L′₃ comprising a barrier polymer chosen from EVOH or an EVOH-based blend, PGA or PDMK;
optionally, a layer L′₄ of an adhesion tie;
a layer L′₅ comprising at least one polyolefin, optionally blended with at least one functionalized polyolefin;
optionally, a barrier layer L′₆; and
optionally, a layer L′₇ comprising at least one polyolefin, optionally blended with at least one functionalized polyolefin,
   characterized in that the PVDF onto which the unsaturated polar monomer is grafted is a copolymer of VDF, the weight content of which is at least 50%, preferably at least 75%, and at least one monomer copolymerizable with VDF, having the following characteristics:
a crystallization temperature T_{c} (measured by DSC according to ISO 11357-3 standard) ranging from 50 to 120° C., preferably 85 to 110° C.;
a yield strength σ_{Y} ranging from 10 to 40 MPa, preferably 10 to 30 MPa; and
a melt viscosity η (measured by capillary rheometry at 230° C./100 s⁻¹) ranging from 100 to 1500 Pa·s, preferably 400 to 1200 Pa·s.

The invention also relates to the use of the multilayer pipe for transporting water, especially hot water, chemicals or a gas, especially for conveying hot water in an underfloor heating system or for conveying hot water to a radiating element.

### DETAILED DESCRIPTION OF THE INVENTION

As regards the modified PVDF, this is a VDF (vinylidene fluoride, CH₂═CF₂) copolymer, the VDF weight content of which is at least 50%, preferably at least 75%, and at least one monomer copolymerizable with VDF. The comonomer may be for example vinyl fluoride (VF), trifluoroethylene, chlorotrifluoroethylene (CTFE), 1,2-difluoroethylene, tetrafluoroethylene (TFE), hexafluoropropene (HFP), 3,3,3-trifluoropropene and 2-trifluoromethyl-3,3,3-trifluoro-1-propene. Preferably, for ease of extrusion reasons, it is a thermoplastic PVDF.

VDF/HFP copolymers are preferred in which the HFP weight content varies from 4 to 22%, preferably 10 to 20% (the content being calculated before the unsaturated polar monomer is grafted).

The PVDF also has the following properties (before undergoing grafting):
a crystallization temperature T_{c} (measured by DSC according to ISO 11357-3 standard) ranging from 50 to 120° C., preferably 85 to 110° C.;
a yield strength σ_{Y} ranging from 10 to 40 MPa, preferably 10 to 30 MPa; and
a melt viscosity η (measured by capillary rheometry at 230° C./100 s⁻¹) ranging from 100 to 1500 Pa·s, preferably 400 to 1200 Pa·s.

It also has, before grafting, a tensile Young's modulus (ASTM-D638) that preferably ranges from 200 to 1000 MPa, preferably 200 to 600 MPa.

Compared with the KYNARFLEX® 2801 grade that is described in EP 1508927, the PVDF that is modified has initially a lower viscosity which means that, after modification, the viscosity of the functionalized PVDF is also lower than that of the modified KYNARFLEX® 2801. This makes it easier to process the functionalized PVDF, whether in the melt state or in solution in a solvent.

The functionalized PVDF, or the blend, has, compared with the functionalized PVDFs of the prior art, the following advantages:
greater adhesion of the layer comprising the functionalized PVDF to the layers that are in contact with it;
easier processability, whether in the melt state or in solution in a solvent; and
it also allows a higher coextrusion rate.

The KYNARFLEX® 2500 and 2750 grades, sold by Arkema, are examples of suitable PVDFs:

Characteristics of KYNARFLEX® 2500
VDF/HFP copolymer having 19% HFP;
T_{c}: 87.4° C.;
σ_{Y}: 15 MPa;
η: 1000 Pa·s;
tensile Young's modulus: 220 MPa.

Characteristics of KYNARFLEX® 2750
VDF/HFP copolymer having 16% HFP;
T_{c}: 103° C.;
σ_{Y}: 18 MPa
η: 900 Pa·s
tensile Young's modulus: 360 MPa.

With regard to the functionalized PVDF, this is obtained by radiation-grafting at least one unsaturated polar monomer onto the PVDF defined above. This will then be referred to as functionalized PVDF.

The process comprises the following steps:

a). the PVDF is blended beforehand with the unsaturated polar monomer by any melt-blending technique known in the prior art. The blending step is carried out in any blending device, such as extruders or mixers used in the thermoplastics industry. Preferably, an extruder will be used to make the blended compound in the form of granules. The grafting therefore takes place on a compound (throughout the mass) and not on the surface of a powder, as described for example in document U.S. Pat. No. 5,576,106.

The proportion of PVDF by weight is from 80 to 99.9%, preferably from 90 to 99%, per 0.1 to 20%, preferably 1 to 10% of unsaturated polar monomer, respectively.

b). next, the compound is irradiated (β or γ radiation) in the solid state using an electron or photon source with an irradiation dose of between 10 and 200 kGray, preferably between 10 and 150 kGray. The compound may, for example, be packaged in polyethylene bags, the air is expelled and then the bags are closed. Advantageously, the dose is between 2 and 6 Mrad and preferably between 3 and 5 Mrad. It is particularly preferred to carry out the irradiation in a cobalt⁶⁰ bomb.

The grafted unsaturated polar monomer content is, by weight, between 0.1 and 5% (that is to say the grafted unsaturated polar monomer corresponds to 0.1 to 5 parts per 99.9 to 95 parts of PVDF), advantageously from 0.5 to 5% and preferably from 0.9 to 5%. This content depends on the initial content of the unsaturated polar monomer in the compound to be irradiated. It also depends on the efficiency of the grafting, and therefore on the duration and the energy of the irradiation; and

c). any unsaturated polar monomer that has not been grafted and the residues released by the grafting, especially HF, may then be optionally removed. The latter step may be necessary if the ungrafted unsaturated polar monomer is liable to impair the adhesion or to cause toxicological problems. This operation may be carried out using techniques known to those skilled in the art. A vacuum degassing operation may be applied, optionally applying heating at the same time. It is also possible to dissolve the functionalized PVDF in a suitable solvent, such as for example N-methylpyrrolidone, and then to precipitate it in a non-solvent, for example in water or in an alcohol, or else to wash the functionalized PVDF using a solvent that is inert with respect to the fluoropolymer and to the grafted functional groups. For example, when maleic anhydride is grafted, the fluoropolymer may be washed with chlorobenzene.

One of the advantages of this radiation grafting process is that it is possible to obtain higher grafted unsaturated polar monomer contents than with the conventional grafting processes using a radical initiator. Thus, with the radiation grafting process, it is typically possible to obtain contents of greater than 1% (1 part of unsaturated monomer per 99 parts of PVDF), or even greater than 1.5%, something that is not possible with a conventional grafting process carried out in an extruder.

Moreover, the radiation grafting takes place “cold”, typically at temperatures below 100° C., or even below 50° C., so that the compound to be irradiated is not in the melt state, as in the case of a conventional grafting process carried out in an extruder. One essential difference is that the grafting takes place in the amorphous phase and not in the crystalline phase, whereas homogeneous grafting takes place in the case of melt grafting in an extruder. The unsaturated polar monomer is therefore not distributed along the PVDF chains in the same way in the case of radiation grafting as in the case of grafting carried out in an extruder. The functionalized PVDF product therefore has a different distribution of unsaturated polar monomer among the PVDF chains compared with a product obtained by grafting carried out in an extruder.

During this grafting step, it is preferable to prevent oxygen from being present. It is therefore possible to remove the oxygen by flushing the compound to be irradiated with nitrogen or argon. The functionalized PVDF has the very good chemical resistance and oxidation resistance and the good thermomechanical properties of the copolymer before it is modified.

The functionalized PVDF may be used by itself or else blended with another PVDF, which may be a PVDF homopolymer or a PVDF copolymer. Preferably, this other PVDF is chosen so that the two fluoropolymers are compatible and the blend has only a single DSC melting peak. Preferably, the other PVDF is a copolymer of VDF and at least one monomer copolymerizable with VDF, said copolymer having a VDF weight content of at least 50%, preferably at least 75%, and having the same thermal and mechanical properties specified above in the case of the PVDF that is modified. The blend comprises, by weight, 1 to 99%, preferably 50 to 99%, of the functionalized PVDF per 99 to 1%, preferably 1 to 50%, respectively, of another PVDF. The blend may be produced by melt blending using a mixing tool suitable for thermoplastics, for example using an extruder.

With regard to the unsaturated polar monomer, this possesses a C═C double bond, and at least one polar functional group that may be one of the following functional groups:
a carboxylic acid;
a carboxylic acid salt;
a carboxylic acid anhydride;
an epoxide;
a carboxylic acid ester;
a silyl;
an alkoxysilane;
a carboxylic acid amide;
a hydroxyl;
an isocyanate.

It is also possible to envisage using mixtures of several monomers.

Unsaturated carboxylic acids having 4 to 10 carbon atoms and their functional derivatives, particularly their anhydrides, are particularly preferred unsaturated monomers. Mention may be made by way of examples of unsaturated monomers of methacrylic acid, acrylic acid, maleic acid, fumaric acid, itaconic acid, citraconic acid, undecylenic acid, allylsuccinic acid, cyclohex-4-ene-1,2-dicarboxylic acid, 4-methylcyclohex-4-ene-1,2-d icarboxylic acid, bicyclo[2.2.1]hept-5-ene-2,3-dicarboxylic acid, x-methylbicyclo-[2.2.1]hept-5-ene-2,3-dicarboxylic acid, zinc, calcium or sodium undecylenate, maleic anhydride, itaconic anhydride, citraconic anhydride, dichloromaleic anhydride, difluoromaleic anhydride, crotonic anhydride, glycidyl acrylate, glycidyl methacrylate, allyl glycidyl ether and vinylsilanes, such as vinyltrimethoxysilane, vinyltriethoxysilane, vinyltriacetoxysilane and γ-methacryloxypropyltrimethoxysilane.

Other examples of unsaturated monomers comprise C₁-C₈ alkyl esters or glycidyl ester derivatives of unsaturated carboxylic acids, such as methyl acrylate, methyl methacrylate, ethyl acrylate, ethyl methacrylate, butyl acrylate, butyl methacrylate, glycidyl acrylate, glycidyl methacrylate, monoethyl maleate, diethyl maleate, monomethyl fumarate, dimethyl fumarate, monomethyl itaconate and diethyl itaconate; amide derivatives of unsaturated carboxylic acids, such as acrylamide, methacrylamide, the monoamide of maleic acid, the diamide of maleic acid, the N-monoethylamide of maleic acid, the N,N-diethylamide of maleic acid, the N-monobutylamide of maleic acid, the N,N-dibutylamide of maleic acid, the monoamide of fumaric acid, the diamide of fumaric acid, the N-monoethylamide of fumaric acid, the N,N-diethylamide of fumaric acid, the N-monobutylamide of fumaric acid and the N,N-dibutylamide of fumaric acid; imide derivatives of unsaturated carboxylic acids, such as maleimide, N-butylmaleimide and N-phenylmaleimide; and metal salts of unsaturated carboxylic acids, such as sodium acrylate, sodium methacrylate, potassium acrylate, potassium methacrylate and zinc, calcium or sodium undecylenate.

Excluded from the monomers are those that have two C═C double bonds, which could result in crosslinking of the fluoropolymer, such as for example diacrylates or triacrylates. From this point of view, maleic anhydride just like zinc, calcium and sodium undecylenates are preferred, as these have little tendency to homopolymerize or even to cause crosslinking.

Advantageously maleic anhydride is used, as this monomer has the following advantages:
it is solid and can be easily introduced with the fluoropolymer granules before melt blending;
being solid, it is also easier to handle (in particular it is not very volatile),
it allows good adhesion properties to be obtained;
it is particularly reactive with respect to many chemical functional groups; and
unlike other unsaturated monomers, such as (meth)acrylic acid or acrylic esters, it does not homopolymerize and does not have to be stabilized.

In the compound that has to be irradiated, the proportion of PVDF by weight is between 80 and 99.9% per 0.1 to 20% of unsaturated monomer, respectively. Preferably, the proportion of PVDF is from 90 to 99% per 1 to 10% of unsaturated polar monomer, respectively.

As regards the fluorinated polymer, this denotes any polymer having in its chain at least one monomer chosen from compounds that contain a vinyl group capable of opening in order to be polymerized and that contains, directly attached to this vinyl group, at least one fluorine atom, a fluoroalkyl group or a fluoroalkoxy group.

As examples of monomers, mention may be made of vinyl fluoride; vinylidene fluoride (VDF, CH₂═CF₂); trifluoroethylene (VF3); chlorotrifluoroethylene (CTFE); 1,2-difluoroethylene; tetrafluoroethylene (TFE); hexafluoropropylene (HFP); perfluoro(alkyl vinyl)ethers, such as perfluoro(methyl vinyl)ether (PMVE), perfluoro(ethyl vinyl)ether (PEVE) and perfluoro(propyl vinyl)ether (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₂OCN or CH₂OPO₃H; the product of formula CF₂═CFOCF₂CF₂SO₂F; the product of formula F(CF₂)ₙCH₂OCF═CF₂ in which n is 1, 2, 3, 4 or 5; the product of formula R₁CH₂OCF═CF₂ in which R₁ is hydrogen or F(CF₂)_{z} and z is 1, 2, 3 or 4; the product of formula R₃OCF═CH₂ in which R₃ is F(CF₂)_{z}— and z is 1, 2, 3 or 4; perfluorobutylethylene (PFBE); 3,3,3-trifluoropropene and 2-trifluoromethyl-3,3,3-trifluoro-1-propene.

The fluoropolymer may be a homopolymer or a copolymer; it may also include non-fluorinated monomers such as ethylene or propylene.

As an example, the fluoropolymer is chosen from:
homopolymers and copolymers of vinylidene fluoride (VDF, CH₂═CF₂) containing, by weight, at least 50% VDF. The VDF copolymer may be chosen from chlorotrifluoroethylene (CTFE), hexafluoropropylene (HFP), trifluoroethylene (VF3) and tetrafluoroethylene (TFE);
ethylene/TFE copolymers (ETFE);
homopolymers and copolymers of trifluoroethylene (VF3);
copolymers of the EFEP type, combining VDF with TFE (for example the EFEPs from Daikin); and
copolymers, and especially terpolymers, combining the residues of chlorotrifluoroethylene (CTFE), tetrafluoroethylene (TFE), hexafluoropropylene (HFP) and/or ethylene units and optionally VDF and/or VF3 units.

Advantageously, the fluoropolymer is a PVDF homopolymer or copolymer. This is because such a fluoropolymer exhibits good chemical resistance, especially

UV resistance and resistance to chemicals, and can be easily converted (more easily than PTFE or ETFE-type copolymers). Preferably, the PVDF contains, by weight, at least 50%, more preferably at least 75% and better still at least 85% VDF. The comonomer is advantageously HFP.

Advantageously, the PVDF has a viscosity ranging from 100 Pa·s to 2000 Pa·s, the viscosity being measured at 230° C. with a shear rate of 100 s⁻¹ using a capillary rheometer. This is because these PVDFs are well suited to extrusion and to injection moulding. Preferably, the PVDF has a viscosity ranging from 300 Pa·s to 1200 Pa·s, the viscosity being measured at 230° C. with a shear rate of 100 s⁻¹ using a capillary rheometer.

With regard to the polyolefin, this term denotes a polymer containing predominantly ethylene and/or propylene units. It may be a polyethylene homopolymer or copolymer, the comonomer being chosen from propylene, butene, hexene or octene. It may also be a polypropylene homopolymer or copolymer, the comonomer being chosen from ethylene, butene, hexene or octene.

The polyethylene may especially be high-density polyethylene (HDPE), low-density polyethylene (LDPE), linear low-density polyethylene (LLDPE) or very low-density polyethylene (VLDPE). The polyethylene may be obtained using a Ziegler-Natta, Phillips or metallocene-type catalyst or using the high-pressure process. The polypropylene is an isotactic or syndiotactic polypropylene.

It may also be a crosslinked polyethylene (denoted XPE). The crosslinked polyethylene may for example be a polyethylene containing hydrolysable silane groups (as described in applications WO 01/53367 or US 20040127641 A1) which has then been crosslinked after the silane groups have reacted together. The reaction between the Si—OR silane groups results in Si—O—Si bonds that link the polyethylene chains together. The content of hydrolysable silane groups may be at least 0.1 hydrolysable silane groups per 100 —CH₂— units (determined by infrared analysis). The polyethylene may also be crosslinked by radiation, for example gamma-radiation. It may also be a polyethylene crosslinked using a radical initiator of the peroxide type. It will therefore be possible to use a type-A XPE (crosslinking using a radical initiator), a type-B XPE (crosslinking using silane groups) or a type-C XPE (radiation crosslinking).

It may also be what is called a bimodal polyethylene, that is to say one composed of a blend of polyethylenes having different average molecular weights, as taught in document WO 00/60001. A bimodal polyethylene makes it possible for example to achieve a very advantageous compromise between impact strength, stress-cracking strength, good rigidity and good pressure resistance.

For pipes that have to be pressure-resistant, especially pipes for transporting pressurized gas or for transporting water, it may be advantageous to use a polyethylene that exhibits good resistance to slow crack growth (SCG) and to rapid crack growth (RCP). The HDPE XS 10 B grade sold by Total Petrochemicals exhibits good crack resistance (slow or rapid crack growth). This is an HDPE containing hexene as comonomer, having a density of 0.959 g/cm³ (ISO 1183), an MI-5 of 0.3 dg/min (ISO 1133), an HLMI of 8 dg/min (ISO 1133), a long-term hydrostatic strength of 11.2 MPa according to ISO/DIS 9080, and a slow crack growth resistance on notched pipes of greater than 1000 hours according to ISO/DIS 13479.

With regard to the functionalized polyolefin, this term denotes a copolymer of ethylene and/or propylene with at least one unsaturated monomer from the above list.

The monomer in saturated monomer is preferably chosen from:
C₁-C₈ alkyl(meth)acrylates, especially methyl, ethyl, propyl, butyl, 2-ethylhexyl, isobutyl and cyclohexyl(meth)acrylate;
unsaturated carboxylic acids and the salts and anhydrides thereof, especially acrylic acid, methacrylic acid, maleic anhydride, itaconic anhydride and citraconic anhydride;
unsaturated epoxides, especially aliphatic glycidyl esters and ethers, such as allyl glycidyl ether, vinyl glycidyl ether, glycidyl maleate, glycidyl itaconate, glycidyl acrylate, glycidyl methacrylate, and alicyclic glycidyl esters and ethers; and
vinyl esters of saturated carboxylic acids, especially vinyl acetate or vinyl propionate.

The functionalized polyolefin may be obtained by copolymerizing ethylene with at least one unsaturated polar monomer chosen from the above list. The functionalized polyolefin may be a copolymer of ethylene with a polar monomer or else a terpolymer of ethylene with two unsaturated polar monomers. The copolymerization takes place at high pressure, above 1000 bar according to what is called the high-pressure process. The functional polyolefin obtained by copolymerization comprises 50 to 99.9%, preferably 60 to 99.9% and even more preferably 65 to 99% ethylene by weight and 0.1 to 50%, preferably 0.1 to 40% and even more preferably 1 to 35% by weight of at least one polar monomer from the above list.

As an example, the functionalized polyolefin may be a copolymer of ethylene with an unsaturated epoxide, preferably glycidyl(meth)acrylate and optionally with a C₁-C₈ alkyl(meth)acrylate or a vinyl ester of a saturated carboxylic acid. The unsaturated epoxide, especially glycidyl (meth)acrylate, weight content is between 0.1 and 50%, advantageously between 0.1 and 40%, preferably between 1 and 35% and even more preferably between 1 and 20%. For example, the functionalized polyolefins may be those sold by Arkema under the references LOTADER® AX8840 (8 wt% glycidyl methacrylate/92 wt % ethylene, with a melt index of 5 according to ASTM D1238), LOTADER® AX8900 (8 wt % glycidyl methacrylate/25 wt % methyl acrylate/67 wt % ethylene, with a melt index of 6 according to ASTM D1238) or LOTADER® AX8950 (9 wt % glycidyl methacrylate/15 wt % methyl acrylate/76 wt % ethylene, with a melt index of 85 according to ASTM D1238).

The functionalized polyolefin may also be a copolymer of ethylene with an unsaturated carboxylic acid anhydride, preferably maleic anhydride, and optionally with a C₁-C₈ alkyl (meth)acrylate or a vinyl ester of a saturated carboxylic acid. The content of carboxylic acid anhydride, especially maleic anhydride, is between 0.1 and 50%, advantageously between 0.1 and 40%, preferably between 1 and 35% and even more preferably between 1 and 10%. For example, the functionalized polyolefins may be those sold by Arkema under the references LOTADER® 2210 (2.6 wt % maleic anhydride/6 wt % butyl acrylate/91.4 wt % ethylene, with a melt index of 3 according to ASTM D1238), LOTADER® 3340 (3 wt % maleic anhydride/16 wt % butyl acrylate/81 wt % ethylene, with a melt index of 5 according to ASTM D1238), LOTADER® 4720 (0.3 wt % maleic anhydride/30 wt % ethyl acrylate/69.7 wt % ethylene, with a melt index of 7 according to ASTM D1238), LOTADER® 7500 (2.8 wt % maleic anhydride/20 wt % butyl acrylate/77.2 wt % ethylene, with a melt index of 70 according to ASTM D1238) or OREVAC 9309, OREVAC 9314, OREVAC 9307Y, OREVAC 9318, OREVAC 9304 or OREVAC 9305.

Also denoted by the term “functionalized polyolefin”, is a polyolefin onto which an unsaturated polar monomer from the above list has been grafted by radical means. The grafting takes place in an extruder or in solution in the presence of a radical initiator. As examples of radical initiators, it will be possible to use tert-butyl hydroperoxide, cumene hydroperoxide, diisopropylbenzene hydroperoxide, di-tert-butyl peroxide, tert-butylcumyl peroxide, dicumyl peroxide, 1,3-bis-(tert-butylperoxyisopropyl)benzene, benzoyl peroxide, isobutyryl peroxide, bis(3,5,5-trimethylhexanoyl)peroxide or methyl ethyl ketone peroxide. The grafting of an unsaturated polar monomer onto a polyolefin is known to those skilled in the art, and for further details the reader may refer for example to documents EP 689505, U.S. Pat. No. 5,235,149, EP 658139, U.S. Pat. No. 6,750,288 B2 and U.S. Pat. No. 6,528,587 B2. The polyolefin onto which the unsaturated polar monomer has been grafted may be a polyethylene, especially high-density polyethylene (HDPE), low-density polyethylene (LOPE), linear low-density polyethylene (LLDPE) or very low-density polyethylene (VLDPE). The polyethylene may be obtained using a Ziegler-Natta, Phillips or metallocene-type catalyst or using the high-pressure process. The polyolefin may also be a polypropylene, especially an isotactic or syndiotactic polypropylene. It may also be a copolymer of ethylene and propylene of the EPR type, or a terpolymer of ethylene, propylene and a diene, of the EPDM type. It may be for example be one of the functionalized polyolefins sold by Arkema under the references OREVAC® 18302, 18334, 18350, 18360, 18365, 18370, 18380, 18707, 18729, 18732, 18750, 18760, PP-C and CA100.

The polymer onto which the unsaturated polar monomer has been grafted may also be a copolymer of ethylene with at least one unsaturated polar monomer chosen from:
C₁-C₈ alkyl(meth)acrylates, especially methyl, ethyl, propyl, butyl, 2-ethylhexyl, isobutyl and cyclohexyl(meth)acrylates; and
vinyl esters of saturated carboxylic acids, especially vinyl acetate or vinyl propionate.

It may for example be one of the functionalized polyolefins sold by Arkema under the references OREVAC® 18211, 18216 or 18630.

The Multilayer Pipe will now be Described in its Two Embodiments

In the first embodiment, the multilayer pipe comprises (in order from the inside of the pipe outwards), placed against one another:
optionally, a layer L₁ comprising at least one fluoropolymer, preferably a PVDF;
a layer L₂ comprising at least one functionalized PVDF or the blend according to the invention;
optionally, a layer L₃ of an adhesion tie;
a layer L₄ comprising at least one polyolefin optionally blended with at least one functionalized polyolefin;
optionally, a barrier layer L₅; and
optionally, a layer L₆ comprising at least one polyolefin, optionally blended with at least one functionalized polyolefin.

In a second embodiment, the multilayer pipe comprises (in order from the inside of the pipe outwards) placed against one another:
optionally, a layer L′₁ comprising at least one fluoropolymer, preferably a PVDF;
a layer L′₂ comprising at least one functionalized PVDF or the blend of the invention;
a barrier layer L′₃ comprising a barrier polymer chosen from EVOH or an EVOH-based blend, PGA or PDMK;
optionally, a layer L′₄ of an adhesion tie;
a layer L′₅ comprising at least one polyolefin, optionally blended with at least one functionalized polyolefin;
optionally, a barrier layer L′₆; and
optionally, a layer L′₇ comprising at least one polyolefin, optionally blended with at least one functionalized polyolefin.

The internal layer in contact with the fluid is either the layer L₁ or L′₁, or the layer L₂ or L′₂. All the layers of the pipe are preferably concentric. The pipe is preferably cylindrical. The layers adhere to one another in their respective contact regions (that is to say two successive layers are bonded directly to each other). The layers preferably each have a thickness between 0.001 and 10 000 mm, advantageously between 0.01 and 100 mm and preferably between 0.05 and 50 mm.

Advantages of the Multilayer Pipe

The Multilayer Pipe:
exhibits chemical resistance with respect to the transported fluid (via the L₁/L′₁ and/or L₂/L′₂ layers);
stops migration of contaminants from the external environment into the transported fluid;
stops migration of contaminants (antioxidants, additives, catalyst residues or other residues, etc.) present in the thermoplastic polymers; and
stops migration of oxygen or additives present in the transported fluid into the thermoplastic polymer layers.

The Optional Layer L₁ or L′₁

This layer comprises at least one fluoropolymer (not modified by radiation grafting). Preferably, the fluoropolymer is a PVDF homopolymer or copolymer or else a copolymer based on VDF and TFE, of the EFEP type.

The Layer L₂ or L′₂

This layer comprises at least one functionalized PVDF or else the blend according to the invention. It has a barrier function and the function of chemically and mechanically protecting the other layers. In addition, when the pipe comprises a layer L₁ or L′₁, it also has the function of acting as an adhesion tie between L₁ and L₃ or between L′₁ and L′₃.

The Optional Layer L₃

The optional layer L₃ is placed between L₂ and L₄ and has the function of promoting adhesion between these two layers. The adhesive tie comprises at least one polymer that improves the adhesion between these layers.

This polymer may advantageously be a functionalized polyolefin optionally blended with a polyolefin with which it is compatible. If a blend is used, this comprises, by weight, 1 to 99%, advantageously 10 to 90% and preferably 50 to 90% of at least one functionalized polyolefin per 99 to 1%, advantageously 90 to 10% and preferably 10 to 50%, respectively, of at least one polyolefin.

The adhesion is considerably increased if the unsaturated polar monomer that is grafted onto the PVDF possesses one or more chemical functional groups capable of reacting with the chemical functional groups of the functionalized polyolefin. For example, if a monomer containing an acid anhydride functional group is grafted onto the PVDF, the functionalized polyolefin may contain epoxide or hydroxide functional groups. For example, this may be a copolymer of ethylene with an unsaturated epoxide, preferably glycidyl(meth)acrylate, and optionally with a C₁-C₈ alkyl(meth)acrylate or a vinyl ester of a saturated carboxylic acid. Likewise, if an unsaturated polar monomer containing an epoxide or hydroxy functional group is grafted onto the PVDF, the functionalized polyolefin may contain acid anhydride functional groups. For example, this is a copolymer of ethylene with an unsaturated acid anhydride, preferably maleic anhydride, and optionally with a C₁-C₈ alkyl(meth)acrylate.

The Layer L′₃

The barrier layer L′₃ comprises a barrier polymer, which is chosen from EVOH or an EVOH-based blend, polyglycolic acid (PGA) or polydimethylketene (PDMK).

Preferably, an unsaturated polar monomer that possesses one or more chemical functional groups capable of reacting with the functional groups of the polymer barrier is grafted onto the PVDF. For example, in the case of EVOH, very good adhesion is obtained if an unsaturated acid anhydride is grafted onto the PVDF, preferably maleic anhydride.

EVOH is also referred to as saponified ethylene-vinyl acetate copolymer. This is a copolymer having an ethylene content of 20 to 70 mol %, preferably 25 to 70 mol %, the degree of saponification of its vinyl acetate component not being less than 95 mol %. EVOH constitutes a good oxygen barrier and hydrocarbon barrier. Advantageously, the EVOH has a melt flow index of between 0.5 and 100 g/10 min (230° C./2.26 kg), preferably between 5 and 30. It is known that EVOH may contain small proportions of other comonomer ingredients, including alpha-olefins such as propylene, isobutene, alpha-octene, unsaturated carboxylic acids or their salts, partial alkyl esters, complete alkyl esters, etc.

For EVOH-based blends, the EVOH forms the matrix, that is to say the continuous phase, and it represents at least 40%, and preferably at least 50%, by weight of the blend. The other ingredient of the blend is chosen from polyolefins, polyamides and impact modifiers. The impact modifier may be chosen from:
a) functionalized ethylene/alkyl(meth)acrylate copolymers;
b) elastomers, preferably EPRs, EPDMs or NBRs, these elastomers possibly being functionalized; and
c) SBS block copolymers, whether in linear or star block form, optionally hydrogenated (they are then denoted by S-EB-S), these copolymers possibly being functionalized.

The polydimethylketene (PDMK) may be obtained by the pyrolysis of isobutyric anhydride as envisaged in the application FR 2 851 562 which is incorporated here for reference. A process for obtaining polydimethylketene is the following: a) a mixture comprising 1 to 50% by volume of isobutyric anhydride per 99 to 50% of an inert gas, respectively, is preheated at atmospheric pressure to between 300 and 340° C.; b) this mixture is then brought to a temperature of between 400 and 550° C. for a time of between 0.05 and 10 s, in order to obtain a mixture of dimethylketene, inert gas, isobutyric acid and unreacted isobutyric anhydride; c) the above stream is cooled in order to separate the dimethylketene and the inert gas from the isobutyric alcohol and the isobutyric anhydride; d) the dimethylketene is absorbed in a solvent of the saturated or unsaturated, aliphatic or alicyclic and substituted or unsubstituted hydrocarbon type, and then the polymerization of the dimethylketene is initiated using a cationic catalysis system soluble in this solvent and comprising an initiator, a catalyst and a cocatalyst; and e) at the end of the polymerization, the unreacted dimethylketene is removed and the PDMK is separated from the solvent and from the residues of the catalysis system. The catalyst may for example be AlBr₃, the initiator is for example tern' butyl chloride and the cocatalyst is for example o-chloranil.

PGA is a polymer containing at least 60%, advantageously 70% and preferably 80% by weight of the following units (1):

(—O—CH₂—C(═O)—) (1)

This polymer may be manufactured by heating 1,4-dioxane-2-5-dione to a temperature of between 120 and 250° C. in the presence of a catalyst, such as a tin salt, for example SnCl₄. The polymerization takes place in bulk or in a solvent. The PGA may contain the other following units (2) to (6):

(—O—(CH₂)ₙ—O—C(═O)—(CH₂)ₘ—C(═O)) (2)

where n is an integer between 1 and 10 and m is an integer between 0 and 10;

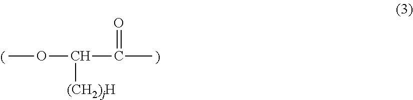

where j is an integer between 1 and 10;

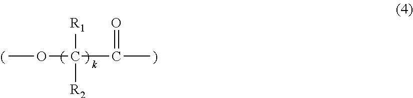

where k is an integer between 2 and 10 and R₁ and R₂ each denote, independently of each other, H or a C₁-C₁₀ alkyl group;

(—OCH₂CH₂CH₂—O—C(═O)—) (5)

or

(—O—CH₂—O—CH₂CH₂—) (6)

The PGA is described in European Patent EP 925 915 B1

The Layer L₄

The layer L₄ comprises at least one polyolefin optionally blended with at least one compatible functionalized polyolefin. In the case of a blend, this comprises, by weight, 1 to 99%, advantageously 10 to 90% and preferably 10 to 50% of a functionalized polyolefin per 99 to 1%, advantageously 90 to 10% and preferably 50 to 90%, respectively, of a polyolefin.

If L₃ is not present, the adhesion between L₂ and L₄ is improved if a blend is used for L₄ such that the functionalized polyolefin contains chemical functional groups that can react with the functional group(s) of the unsaturated polar monomer grafted onto the PVDF.

The Optional Layer L′₄

The optional layer L′₄ is placed between L′₃ and L′₅ and has the function of promoting adhesion between these two layers. The adhesion tie comprises at least one polymer that improves the adhesion between the layers.

This polymer may advantageously be a functionalized polyolefin optionally blended with a polyolefin with which it is compatible. If a blend is used, this comprises, by weight, 1 to 99%, advantageously 10 to 90% and preferably 50 to 90% of at least one functionalized polyolefin per 99 to 1%, advantageously 90 to 10% and preferably 10 to 50%, respectively, of at least one polyolefin.

The Optional Barrier Layer L₅ or L′₆

The function of the barrier layer L₅ and L′₆ is to prevent chemical compounds from diffusing from outside the pipe inwards, and vice versa. For example, it prevents the fluid being contaminated with contaminants. Oxygen and chemicals such as hydrocarbons are for example contaminants. In the more specific case of gases, moisture may be considered as a contaminant.

The barrier layer may comprise a barrier polymer such as, for example:
PDMK;
EVOH or an EVOH-based blend;
PGA.

The barrier layer is preferably a metal sheath. Apart from its barrier function, the metal sheath also has the function of increasing the mechanical strength of the pipe. Another benefit of using a metal sheath is to be able to bend or deform the pipe without it resuming its initial position under the effect of the mechanical stresses generated by the thermoplastic polymer layers. The metal may be steel, copper, aluminium or an aluminium alloy. It is preferably aluminium or an aluminium alloy for corrosion resistance and flexibility reasons. The metal sheath is manufactured according to one of the processes known to those skilled in the art. The reader may refer in particular to the following documents that describe processes for producing plastic/metal composite tubes: U.S. Pat. No. 6,822,205, EP 0 581 208 A1, EP 0 639 411 B1, EP 0 823 867 B1 and EP 0 920 972 A1. Preferably, the process used consists in:
shaping a metal strip so as to go around the already coextruded thermoplastic polymer layers (i.e. L₁-L₄ or L′₁-L′₅), said metal strip having longitudinal edges that are angled towards a common side and placed so as to bear against one another, extending approximately parallel to the longitudinal axis of the plastic pipe; and
the longitudinal edges are then welded together. They therefore form a longitudinal weld seam.

After having welded the longitudinal edges of the metal strip, a tubular metal sheath is therefore obtained.

To improve the adhesion of the barrier layer L₅, an adhesion tie layer may be placed between L₅ and L₄ and/or between L₅ and the optional L₆. Likewise, in the case of the barrier layer L′₆, an adhesion tie layer may be placed between L′₆ and L′₅ and/or between L′₆ and the optional L′₇. The adhesion tie is for example a functionalized polyolefin that contains acid or acid anhydride functional groups, for example (meth)acrylic acid or maleic anhydride. It may for example be a polyethylene or a polypropylene onto which (meth)acrylic acid or maleic anhydride is grafted. Examples of functionalized polyolefins that may be mentioned include those sold by Arkema under the references OREVAC 18302, 18334, 18350, 18360, 18365, 18370, 18380, 18707, 18729, 18732, 18750, 18760, PP-C, CA100 or by Uniroyal Chemical under the reference POLYBOND® 1002 or 1009 (polyethylene onto which acrylic acid has been grafted).

The Optional Layer L₆ or L′₇

The pipe may optionally include a layer L₆ or L′₇ comprising at least one polyolefin. The polyolefins of L₄ and L₆ or of L′₅ and L′₇ may be identical or different. The function of L₆ or L′₇ is to mechanically protect the pipe (for example against impacts on the pipe when it is being installed) and also to mechanically reinforce the entire pipe, thereby allowing the thicknesses of the other layers to be reduced.

Thanks to its good thermomechanical properties, a PEX is advantageously used for L₄ and/or for L₆, or else for L′₅ and/or for L′₇.

Each of the layers of the multilayer pipe, especially the polyolefin layer(s), may contain additives normally used by blending them into thermoplastics, for example antioxidants, lubricants, colorants, fire retardants, mineral or organic fillers, and antistatic agents, such as for example carbon black or carbon nanotubes. The pipe may also include other layers, such as for example an insulating outer layer.

### Example of a Pipe According to the First Preferred Embodiment (Best Mode):

The pipe comprises, placed against one another in the order indicated (from the inside of the pipe outwards):
a layer L₁ comprising at least one PVDF homopolymer or copolymer;
a layer L₂ comprising a functionalized PVDF or the blend according to the invention, the unsaturated polar monomer grafted onto the PVDF being a carboxylic acid anhydride, preferably maleic anhydride;
a layer L₃ comprising at least one functionalized polyolefin possessing functional groups capable of reacting with the carboxylic acid anhydride, optionally blended with a polyolefin. Advantageously, this is a functionalized polyolefin possessing epoxy or hydroxy functional groups. For example, it may be a copolymer of ethylene with an unsaturated epoxide, preferably glycidyl methacrylate, and optionally with a C₁-C₈ alkyl(meth)acrylate;
a layer L₄ comprising at least one polyethylene, preferably of PEX type;
a barrier layer L₅ in the form of a metal sheath, preferably made of aluminium; and
a layer L₆ comprising at least one polyethylene, preferably of PEX type.

Preferably, an adhesion tie layer is placed between L₅ and L₄ and/or between L₅ and L₆. Preferably, the adhesion tie is a functionalized polyolefin containing acid or acid anhydride functional groups, for example (meth)acrylic acid or maleic anhydride. It may for example be a polyethylene or a polypropylene onto which the (meth)acrylic acid or the maleic anhydride has been grafted.

### Example of a Pipe According to the Second Preferred Embodiment (Best Mode)

The pipe comprises, placed against one another in the order indicated (from the inside of the pipe outwards):
a layer L′₁ comprising at least one PVDF homopolymer or copolymer;
a layer L₂ comprising a functionalized PVDF or the blend according to the invention, the unsaturated polar monomer grafted onto the PVDF being a carboxylic acid anhydride, preferably maleic anhydride;
a barrier layer L′₃ comprising an EVOH or an EVOH-based blend;
an adhesion tie layer L′₄;
a layer L′₅ comprising at least one polyethylene, preferably of PEX type;
a barrier layer L′₆ in the form of a metal sheath, preferably made of aluminium; and
a layer L′₇ comprising at least one polyethylene, preferably of PEX type.

Preferably, an adhesion tie layer is placed between L′₆ and L′₅ and/or between L′₆ and L′₇. Preferably, the adhesion tie is a functionalized polyolefin containing acid or acid anhydride functional groups, for example (meth)acrylic acid or maleic anhydride. This may for example be a polyethylene or a polypropylene onto which the (meth)acrylic acid or the maleic anhydride has been grafted.

Pipe Production

The pipe may be manufactured by the technique of coextrusion. This technique is based on the use of as many extruders as there are layers to be extruded.

When the polyolefin is a PEX of type B (crosslinking by silane groups), the process starts by extruding the uncrosslinked polyolefin. The crosslinking reaction is carried out by immersing the extruded pipes in hot water baths to initiate the crosslinking. With a PEX of type A (crosslinking using a radical initiator), the crosslinking reaction is carried out using a radical initiator that is thermally activated during the extrusion. With a PEX of type C, the process starts by extruding all the layers, and then the pipe in its entirety is irradiated to initiate the crosslinking of the polyethylene. The irradiation is performed using an electron beam with a dose of 3 to 35 Mrad.

Use of the Pipe

The multilayer pipe may be used for transporting different fluids.

The pipe is suitable for transporting water, especially hot water, in particular hot water in a networked system. The pipe may be used for transporting hot water for heating (the temperature being above 60° C. or even 90° C.). One example of a useful application is that of underfloor heating in which the pipe used for conveying the hot water is placed under the floor. The water is heated by a boiler and conveyed through the pipe. Another example is that in which the pipe serves to convey hot water to a radiator. The pipe can then be used for radiation water-heating systems. The invention also relates to a networked heating system comprising the pipe of the invention.

The chemical resistance of the pipe is suitable for water containing chemical additives (generally in small amounts, of less than 1%) that may impair polyolefins, especially polyethylene, most particularly when hot. These additives may be oxidizing agents, such as chlorine and hypochlorous acid, chlorinated derivatives, bleach, ozone, etc.

For applications in which the water flowing in the pipe is potable water, water intended for medical or pharmaceutical applications, or a biological liquid, it is preferable to have a layer of an unmodified fluoropolymer as layer in contact with the water (layer L₁ or L′₁). Microorganisms (bacteria, germs, fungal growths, etc.) have little tendency to grow on a fluoropolymer, especially on PVDF. In addition, it is preferable for the layer in contact with the water or the biological liquid to be a layer of unmodified fluoropolymer rather than a layer of modified fluoropolymer, in order to prevent migration of ungrafted (free) unsaturated monomer into the water or the biological liquid.

The barrier properties of the pipe make it useful for transporting water in polluted ground by preventing the migration of contaminants into the transported fluid.

The barrier properties are also useful for preventing the migration of oxygen into the water (DIN-4726), which would be deleterious if the tube is used for transporting hot heating water (the presence of oxygen is a source of corrosion of steel or iron components of the heating installation). It is also desirable to stop the migration of contaminants present in the polyolefin layer (antioxidants, polymerization residues, etc.) into the transported fluid.

More generally, the multilayer pipe can be used for transporting chemicals especially those that are liable to chemically degrade polyolefins.

The multilayer pipe may also be used for transporting gas, especially pressurized gas. When the polyolefin is a polyethylene of the PE80 or PE100 type, it is especially suitable for withstanding pressures of greater than 10 bar, or greater than 20 bar or even greater than 30 bar. The gas may be of a different type. It may be for example:
a gaseous hydrocarbon (for example town gas, a gaseous alkane, especially ethane, propane or butane, or a gaseous alkene, especially ethylene, propylene or butene);
nitrogen;
helium;
hydrogen;
oxygen;
a corrosive gas or one capable of degrading polyethylene or polypropylene. For example, it may be an acid or corrosive gas, for example H₂S or HCl or HF.

The advantage of these pipes for applications associated with air conditioning, in which the gas flowing in the pipes is a cryogen, will also be mentioned. The cryogen may be CO₂, especially supercritical CO₂, an HFC or an HCFC gas. The optional layer L₁/L′₁ or else the layer L₂/L′₂ exhibits good resistance to these gases, as it is a fluoropolymer. Preferably, the fluoropolymer of these layers is PVDF, as this is particularly resistant. It is possible for the cryogen to condense at certain points in the air-conditioning circuit and to be liquid. The multilayer pipe can therefore also be applied to the case in which the cryogenic gas has condensed in the form of liquid.

### EXAMPLES

Products Used:

KYNAR® 720: A PVDF homopolymer from Arkema with a melt flow index of 20 g/10 min (230° C./5 kg) and a melting point of 170° C., having the following characteristics:
T_{c}: 135° C.
σ_{Y}: 55 MPa
η: 900 Pa·s (230° C./100 s⁻¹)
Young's modulus: 2200 MPa.

OREVAC® 18302: an LLDPE-type polyethylene onto which maleic anhydride has been grafted, with a melt flow index of 1 g/110 min and a melting point of 124° C.

LOTADER® AX 8840: an ethylene (92 wt %)/glycidyl methacrylate (8 wt %) copolymer from Arkema, having a melt flow index of 5 according to ASTM D-1238.

PEX: obtained from a blend of 95 wt % BORPEX® ME-2510 and 5 wt % MB-51, both products being sold by Borealis. The crosslinking is carried out by heating and is due to the presence of silane functional groups on the polyethylene.

PVDF-1: a VDF-HFP copolymer having 16% HFP by weight with:
T_{c}: 103° C.
σ_{Y}: 18 MPa
η: 900 Pa·s
tensile Young's modulus: 360 MPa.

### Example 1

### Preparation of a Functionalized PVDF

The PVDF-1 was compounded with 2 wt % maleic anhydride at 190° C. in an extruder of Werner 40 type. This compounding was carried out with all the vents of the extruder closed and with a screw speed of 200 rpm and a throughput of 60 kg/h.

The product, which was granulated by a die-face cutter, was put into a bag having an impermeable aluminium lining. This bag was irradiated at 20 kGray. The product, after being irradiated, was again passed through the extruder at 245° C. under a maximum vacuum and at 200 rpm. The throughput was 25 kg/h. Infrared analysis of the product after this devolatilization step showed a degree of grafting of 0.31% and a free maleic anhydride content of 300 ppm. This product was called functionalized PVDF 1.

### Example 2

### Preparation of a Functionalized PVDF

The conditions of Example 1 were repeated, but with KYNAR® 720 instead of PVDF-1. Infrared analysis of the product after devolatilization showed a degree of grafting of 0.50% and a free maleic anhydride content of 300 ppm. This product was called functionalized PVDF 2.

### Example 3

### Comparative Example

A multilayer pipe (outside diameter: 14 mm) was manufactured using a McNeil extruder, said pipe having the following structure:

KYNAR® 720 (130 μm)/functionalized PVDF 2 (50 μm)/LOTADER® AX 8840 (50 μm)/PEX (780 μm).

The PEX layer was the external layer. All the layers adhered to one another. The extrusion was carried out at 40 m/min under the following conditions:
PE layer: 230° C.
LOTADER® AX 8840: 250° C.
functionalized PVDF: 250° C.
KYNAR® 720: 250° C.

The KYNAR® layer ensured excellent chemical protection of the PEX layer. The adhesion between the functionalized PVDF and the LOTADER® 8840 layers, 5 days after the extrusion, was measured by circumferential peel to be 10 N/cm. The adhesion was of the adhesive failure type.

### Example 4

### Comparative Example

A pipe having the following structure was manufactured under the same conditions as in Example 3:

KYNAR® 720 (130 μm)/functionalized PVDF 2 diluted to 50% in a VDF-HFP copolymer containing 16% HFP and having a viscosity at 230° C./100 s⁻¹ of 900 Pa·s (50 μm)/LOTADER® AX 8840 (50 μm)/PEX (780 μm).

The extrusion was carried out at 40 m/min. The PEX layer was the external layer. All the layers adhered to one another. The adhesion between the PVDF blend and the LOTADER® 8840 was measured by circumferential peel after 5 days to be 20 N/cm. The adhesion was of the adhesive failure type.

### Example 5

### According to the Invention

A pipe having the following structure was manufactured under the same conditions as in Example 3:

KYNAR® 720 (130 μm)/functionalized PVDF 1 (50 μm)/LOTADER® AX 8840 (50 μm)/PEX (780 μm).

The extrusion was carried out at 40 m/min. The adhesion was measured by circumferential peel after 5 days to be 60 N/cm. The adhesion was of the cohesive failure type, failure occurring in the LOTADER® 8840 layer.

TABLE I

| | Nature of X in a KYNAR ® 720/X/ | | |
|---|---|---|---|
| | LOTADER ® AX 8840/PEX | | |
| Ex. | structure | Adhesion | |
| 3 (comp.) | Functionalized PVDF 2 | Adhesive | 10 N/cm |
| 4 (comp.) | Functionalized PVDF 2 diluted to | Adhesive | 20 N/cm |
| | 50% in a VDF-HFP copolymer | | |
| | containing 16% HFP and having a | | |
| | viscosity at 230° C./100 s⁻¹ of | | |
| | 900 Pa · s | | |
| 5 (inv.) | Functionalized PVDF 1 | Cohesive | 60 N/cm |

In the structures of Examples 3 to 5, the LOTADER® AX 8840 served as adhesion binder between the functionalized PVDF and the PEX.

1. Multilayer pipe comprising (in order from the inside of the pipe outwards), placed against one another:
optionally, a layer L₁ comprising at least one fluoropolymer;
a layer L₂ comprising at least one functionalized polyvinylidene fluoride (PVDF), obtained by radiation-grafting at least one unsaturated polar monomer onto a PVDF;
optionally, a layer L₃ of an adhesion tie;
a layer L₄ comprising at least one polyolefin optionally blended with at least one functionalized polyolefin;
optionally, a barrier layer L₅; and
optionally, a layer L₆ comprising at least one polyolefin, optionally blended with at least one functionalized polyolefin,
wherein the PVDF onto which the unsaturated polar monomer is grafted is a copolymer of VDF, the weight content of which is at least 50%, preferably at least 75%, and at least one monomer copolymerizable with VDF, having the following characteristics:
a crystallization temperature T_{c} (measured by DSC according to ISO 11357-3 standard) ranging from 50 to 120° C., preferably 85 to 110° C.;
a yield strength σ_{Y} ranging from 10 to 40 MPa, preferably 10 to 30 MPa; and
a melt viscosity η (measured by capillary rheometry at 230° C./100 s⁻¹) ranging from 100 to 1500 Pa·s, preferably 400 to 1200 P19 s.

2. Multilayer pipe of claim 1 further comprising between layer L₂ and optional layer L₃ or layer L₄
a barrier layer L′₃ comprising a barrier polymer chosen from EVOH or an EVOH-based blend, PGA or PDMK.

3. Multilayer according to claim 1, wherein the barrier layer L₅ or L^{′}₆ is a metal sheath.

4. Multilayer pipe according to claim 1 comprising, placed against one another in the order indicated (from the inside of the pipe outwards):
a layer L₁ comprising at least one PVDF homopolymer or copolymer;
a layer L₂ comprising at least one functionalized PVDF, obtained by radiation-grafting maleic anhydride, onto a PVDF;
a layer L₃ comprising at least one functionalized polyolefin possessing functional groups capable of reacting with the carboxylic acid anhydride, optionally blended with a polyolefin;
a layer L₄ comprising at least one polyethylene,
a barrier layer L₅ in the form of an aluminum metal sheath; and
a layer L₆ comprising at least one polyethylene.

5. (canceled)

6. Multilayer pipe according to claim 1, wherein the PVDF onto which the unsaturated polar monomer is grafted has, before grafting, a tensile Young's modulus ranging from 200 to 1000 MPa.

7. Multilayer pipe according to claim 1, further comprising an adhesion tie layer placed:
between L₅ and L₄ and/or between L₅ and L₆.

8. Multilayer pipe according to claim 1, wherein the functionalized PVDF of the layer L₂ is blended with another PVDF homopolymer or copolymer.

9. Multilayer pipe according to claim 8, wherein the functionalized PVDF and the PVDF are compatible and in that the blend has only a single DSC melting peak.

10. (canceled)

11. Multilayer pipe according to claim 1, wherein the PVDF has a tensile Young's modulus (ASTM D-638) that ranges from 200 to 1000 MPa.

12. Multilayer pipe as defined in claim 1 having contained within said pipe water, hot water, chemicals or a gas.

13. Multilayer pipe as defined in claim 12 comprising a means for conveying hot water in an underfloor heating system or for conveying hot water to a radiating element.

14. (canceled)

15. Multilayer pipe according to claim 12, wherein the gas is a gaseous hydrocarbon, nitrogen, helium, hydrogen, oxygen or a gas that is corrosive or liable to degrade polyethylene or polypropylene, or a cryogen.

16. Multilayer pipe of claim 13 comprising a part of a radiation heating system.

17. The multilayer pipe of claim 1, wherein in layer L₁, said fluoropolymer is a polyvinylidene fluoride (PVDF); and wherein the
optionally, a barrier layer L₅; and
optionally, a layer L₆ comprising at least one polyolefin, optionally blended with at least one functionalized polyolefin,
wherein the PVDF onto which the unsaturated polar monomer is grafted is a copolymer of VDF, the weight content of which is at least 50%, preferably at least 75%, and at least one monomer copolymerizable with VDF, having the following characteristics:
a crystallization temperature T_{c} (measured by DSC according to ISO 11357-3 standard) ranging from 50 to 120° C., preferably 85 to 110° C.;
a yield strength σ_{Y} ranging from 10 to 40 MPa, preferably 10 to 30 MPa; and
a melt viscosity η (measured by capillary rheometry at 230° C./100 s⁻¹) ranging from 100 to 1500 Pa·s, preferably 400 to 1200 Pa·s.
